(19) United States
(12) Patent Application Publication
(10) Pub. No.: US 2020/0348033 A1
(43) Pub. Date: Nov. 5, 2020

(54) DEVICE AND SYSTEM FOR PURIFYING AIR AND METHOD OF USE

(71) Applicant: Trittec AG, Wittenförden (DE)

(72) Inventor: Robert Krüger, Trittau (DE)

(21) Appl. No.: 16/961,374

(22) PCT Filed: Jan. 9, 2019
(86) PCT No.: PCT/EP2019/000003

§ 371 Date: Jul. 10, 2020

(30) Foreign Application Priority Data
Jan. 12, 2018 (DE) 10 2018 100 676.4
Jun. 8, 2018 (DE) 10 2018 209 199.4
Jul. 4, 2018 (DE) 10 2018 211 039.5
Jul. 4, 2018 (DE) 10 2018 211 040.9
Jul. 4, 2018 (DE) 10 2018 211 049.2

(51) Int. Cl. F24F 3/16; B01D 53/30; B01D 53/04

(52) U.S. Cl. CPC F24F 3/1603; B01D 53/30; B01D 53/0407; B01D 2253/102; B01D 2259/4558; B01D 2258/06; F24F 2003/1657; F24F 2003/1635

(57) ABSTRACT

A device for cleaning air, particularly outdoors, includes at least one housing (2) having at least one air inlet (3), filter means (4, 5), at least one fan (6), and at least one air outlet (8, 108, 208). The device is inexpensive and easy to use, and enables the user to remove pollutants from air at arbitrary times at arbitrary location because the device is transportable and implemented for positioning at different installation sites. The device may include transport means (11), particularly a chassis (11) having wheels (12). An arrangement may include a plurality of devices for cleaning air, and a software-based application, particularly a smartphone application, may be used for controlling the plurality of devices for cleaning air.

### TECHNICAL FIELD

The present invention relates to a device for cleaning air, particularly outdoors, comprising at least one housing comprising at least one air inlet, filter means, at least one fan, and at least one air outlet.

The present invention further relates to an arrangement of a plurality of devices for cleaning air.

The present invention further relates to a software-based application, particularly a smartphone application, for devices for cleaning air.

### BACKGROUND

The high demand of humanity for electrical power, currently generated in large part by means of combustion power plants from fossil fuels, such as coal, produces substantial pollution of breathing air. The motor vehicles, aircraft, and ships required for human mobility, currently also primarily powered by combustion power plants burning fossil fuels, also cause substantial emissions that greatly pollute breathing air. The emissions include not only CO2 produced in combustion, but also nitrogen oxides NOₓ and particulates that pollute breathing air. Further emissions that additionally pollute breathing air can include, for example, abrasion from tires or braking dust produced when operating motor vehicle brakes.

When cleaning the air polluted by the emissions indicated above outdoors, it must be considered that large amounts of air must be filtered in order to achieve a noticeable cleaning effect. It must also be considered that the installation sites at which cleaning of air is required vary over time, because the causes responsible for polluting the air, such as motor vehicles powered by combustion engines, take effect at different locations depending on the time.

A device of the type indicated above is known from WO 2017/1799984 A1. The known device is particularly suitable for cleaning air polluted with particulate matter. For the known device, various filters and air ionizers are used. The known device is installed on an installation surface by means of an installation table and is connected to a power supply. The device can be placed on a building or in a residential space, for example, in order to clean the air in the surrounding area of the device.

A disadvantage of the known device is that the device is confined to the initially selected installation site and installing the device at a different location is associated with substantial effort and cost, and the peripheral conditions required for the device, such as sufficient installation space and a sufficiently sized electrical power connection, are not always available.

A further disadvantage of the known device is that the device produces substantial noise emissions.

### SUMMARY

It is one object of the present invention is to provide a device for cleaning air, particularly outdoors, an arrangement of a plurality of devices for cleaning air, and a software-based application, particularly a smartphone application, for devices for cleaning air, being inexpensive and simple to use, and enabling the user to clean pollutants from air at arbitrary times and arbitrary places.

A further object of the invention is to provide a device for cleaning air, particularly outdoors, an arrangement of a plurality of devices for cleaning air, and a software-based application, particularly a smartphone application, for devices for cleaning air, stirring up less dirt and causing lower noise emissions than the devices known from the prior art.

According to the present disclosure, a device of the type indicated above is implemented for being transported and positioned at different installation sites. It is thereby possible to transport the device from one installation site to another installation site and to install the device there. The device can thus be operated with little effort at different installation sites where cleaning the air is particularly required and/or sensible. Installing at the installation site can preferably take place by means of mechanical and/or hydraulic lifting systems, wherein the lifting systems particularly enable installing on uneven surfaces. It is also thereby possible to install the device at the installation site such that the travel wind from motor vehicles on the road presses the air to be cleaned into the air inlet of the device, for example. In this manner, the fan driving power required for intaking the air to be cleaned can be advantageously reduced.

Further, a device of the type indicated above is configured in such a way that at least one of the fans is disposed along a flow direction between the filter means. A reduction in noise emissions of the air cleaner, primarily caused by the fan, is hereby achieved. The fan in the present embodiment of the air cleaner according to the invention is also exposed to a reduced quantity of air particles in the airflow due to the installed position downstream of a filter. The abrasive wear of the fan is thereby advantageously reduced. The features according to the invention are advantageous both for transportable embodiments and for embodiments permanently installed, on a foundation, and/or anchored at the installation site.

Further, a device of the type indicated above is configured in such a way that the air inlet for intaking the air is implement horizontal to an installation surface when used properly, and/or the air outlet for discharging the air is implemented vertical to an installation surface. It is thereby advantageously achieved that the intaking and discharging of the air are not in the same direction. For one thing, the proportion of already cleaned air taken in is thereby advantageously reduced. For another, stirring up of dirt and/or blowing on persons and/or vehicles passing by the air cleaner is advantageously avoided in this manner. The noise emissions at the air outlet are also advantageously reduced in this manner.

Further, a device of the type indicated above is configured in such a way that a flow direction of the air at the air inlet is at a right angle to a flow direction at the air outlet when used properly. It is thereby advantageously achieved that the intaking and discharging of the air are not in the same direction. For one thing, the proportion of already cleaned air taken in is thereby advantageously reduced. For another, stirring up of dirt and/or blowing on persons and/or vehicles passing by the air cleaner is advantageously avoided in this manner. The noise emissions at the air outlet are also advantageously reduced in this manner.

According to an advantageous embodiment of the device according to the invention, the device comprising air deflecting means disposed between the air inlet and the air outlet. The air deflecting means enable deflecting the air, that is, changing the flow direction of the air. Air deflecting means can be air deflecting units mounted downstream of the air outlet and/or upstream of the air outlet in the form of a 90 degree pipe elbow or in the form of a box having two openings offset 90 degrees from each other.

According to a further advantageous embodiment of the device according to the invention, an air deflecting means inlet area is greater than an air deflecting means outlet area, and preferably the air deflecting means inlet area is approximately three times the size of the air deflecting means outlet area. A higher flow velocity of the air is thereby advantageously achieved at the air outlet.

According to an advantageous embodiment of the device according to the invention, the device comprises transport means, particularly a chassis having wheels. In this manner, the device comprises transport means required for transporting the device, so that simple and rapid transport of the device is possible. A potential transport means can be a chassis connected permanently and/or releasably to the device similar to a chassis of a trailer. Alternatively, the transport means within the scope of the invention can also be trucks, truck trailers, and/or cargo aircraft, such as helicopters and/or cargo dirigibles.

In a further advantageous embodiment of the device according to the invention, it is provided that the transport means comprise drive means, particularly wheels driven by a motor.

The device for cleaning air is thereby implemented for self-propelled transport without additional means such as a passenger car and/or a truck.

In an advantageous embodiment of the device according to the invention, it is provided that the device is implemented for autonomous mobility. In this manner, the device for cleaning air is implemented as a device for autonomously displacing from installation site to installation site. No driver is required, so that the device can be operated inexpensively and flexibly.

According to a further advantageous embodiment of the device according to the invention, the housing has the dimensions of a standard container. For one thing, it is thereby ensured that the dimensions permit simple and rapid transport, because the dimensions of containers are designed so that the containers can be transported by different means, such as by truck or passenger car having a trailer, including on roads without special permission. For another, the standardized dimensions of a container enable stacking a plurality of devices. Larger systems having greater cleaning capacity can thereby be produced from a plurality of devices.

In an advantageous embodiment of the device according to the invention, it is provided that the housing is implemented for a flow direction horizontal to an installation surface when used properly. The design having horizontal air guiding is particularly well suited for the dimensions of a standard container having the greatest extent thereof in the horizontal longitudinal direction and enables a compact yet standardized construction. In a further advantageous embodiment of the device according to the invention, it is provided that the device comprises power supply means. The power supply means advantageously serve to provide power to the components of the device, particularly the electrical power required for operating.

In an advantageous embodiment of the device according to the invention, it is provided that the power supply means comprise power generation means, particularly a photovoltaic system and/or a fuel cell. The device for cleaning air is thereby supplied with power at the installation site, and in the case of a photovoltaic system, with regenerative power. An external power supply is not absolutely necessary. Installation of the device is thereby facilitated, because no power supply needs to be connected to the device at the installation site. Alternatively to a photovoltaic system and/or fuel cell, other types of power generating means can also be used in the scope of the invention. The means can preferably be wind power generators and/or generators powered by fuels such as gas, gasoline, and/or diesel.

According to a further advantageous embodiment of the device according to the invention, the power supply means comprise power connecting means, particularly an electrical power connection. The device for cleaning air is thereby supplied with power at the installation site. The design is advantageous for operating the device in the case that an external power supply is present at the installation site, because the device is thereby implemented for operating at high power consumption regardless of other surrounding conditions, particularly weather conditions.

In a further advantageous embodiment of the device according to the invention, it is provided that the power supply means comprise energy storage means, particularly batteries. The device for cleaning air is thereby supplied with power at the installation site. The energy stored in the energy storage means can be retrieved when needed for operating the device. In this manner, the device can also be operated if no external electrical power connection and/or no power generating means are present. By means of the energy storage means, it is also possible to store excess generated capacity, for example of a photovoltaic system, not necessary for operating the device. The energy storage means can also be charged with energy in the case that an electrical power supply is connected. Alternatively to battery, other types of energy storage means can be used in the scope of the invention. The means can preferably be capacitors and/or compressed air stores.

In an advantageous embodiment of the device according to the invention, it is provided that the power supply means comprise power recuperation means, particularly an exhaust wind generator. In this manner, it is possible to recapture part of the energy required for operating the fan for displacing the air through the filter, in that the air flow downstream of the filter drives an exhaust wind generator generating electrical energy for storing in energy storage means, preferably in batteries.

According to a further advantageous embodiment of the device according to the invention, the air inlet of the housing can be disposed at a height in the range from 1.5 m to 2.5 m, preferably 2 m, above the installation surface when used properly. Intaking the polluted air at the height is particularly advantageous, because the concentration of pollutants and nitrogen oxides is particularly high at the height above the ground or the road on which motor vehicles drive and thus high cleaning efficiency, expressed in the quantity of pollutants or particulate matter and/or nitrogen oxides per unit of time, can be achieved.

According to a further advantageous embodiment of the device according to the invention, the filter means comprise pre-filter means, particulate matter filter means, and/or activated carbon filter means. The particulate matter filter means are thereby particularly implemented for cleaning particulate matter from the air, such as soot, tire dust, and brake dust, while the activated carbon filter means is particularly implemented for cleaning nitrogen oxides and other gaseous products of combustion from the air. The pre-filter means, such as a woven fabric, are implemented in contrast for pre-cleaning the air prior to entering into the particulate matter filter means. Separating of larger particles that would quickly clog the particulate matter filter means is thereby advantageously achieved.

In an advantageous embodiment of the device according to the invention, the filter means, particularly the pre-filter means, comprise threads comprising carrier means for triboelectrically charging by an air flow, the threads having a coating, particularly a full coating, comprising a hydrophobic coating material. Threads having a hydrophobic coating, preferably known threads from WO 2012/003852, build up a static charge automatically from the air without requiring any active charging. A corresponding thread is thereby excellently suited for producing a filter means having a mesh structure. This is because the automatic charging capability and the further empirically observed long-term preventing of discharge of electrostatic charge for a suitable selection of the carrier material advantageously permits the mesh size of a woven fabric produced from the thread according to the invention to be selected in a size excellently suitable for the filter means.

According to a further advantageous embodiment of the device according to the invention, the filter means, particularly the pre-filter means, comprises threads comprising a core, wherein the core comprises a coating having heat-activated adhesive for materially bonding to itself or to other threads, wherein the core has a higher melting point than the adhesive, wherein the coating comprises hydrophobic repelling means. Such a thread, preferably the known thread from DE 10.2011.057.150, permits locally limited adhesion of warp threads and weft threads at node points of the woven fabric of the filter material. By selecting a heat-activate adhesive, the handling of the thread in a deactivated, non-sticky state present at all natural ambient temperatures is completely without difficulty. The activating of the adhesive takes place in a conceivably simple manner, namely by heating. By means of the temperature, it can thus be very precisely controlled when the thread adhesive is activated and deactivated. It has been found to be particularly advantageous that the core comprises a higher melting point than the adhesive. The adhesive can thus be melted and therefore activated, but without the core melting or substantially softening, in order to prevent the thread from tearing while adhering. Because the temperature is a very well controlled process parameter, industrial production of the thread and also the woven fabric can be performed under simple and thus inexpensive conditions. The scope of the invention includes coating completely enclosing the thread, but also such that are implemented as strips parallel to the longitudinal axis of the thread or rings of finite width extending along the circumference of the thread. Discrete, punctiform coating patterns are also possible. The thread can be particularly efficiently processed into a woven fabric for filter means.

According to a further advantageous embodiment of the device according to the invention, the fan is implemented as an in-line fan and/or as a fan having a controllable disc armature motor and/or having reverse-curved blades. The embodiment according to the invention having an in-line fan is advantageous because in-line fans are typically inexpensive, compactly installed standard fans. The embodiment according to the invention having a fan having a controllable disc armature motor and/or reverse-curved blades is further advantageous because the types of fins are particularly energy-efficient and quiet.

According to a further advantageous embodiment of the device according to the invention, at least one of the fans is disposed between the particulate matter filter means and the activated carbon filter means and/or between the pre-filter means and the particulate matter filter means along a flow direction. A reduction in noise emissions of the air cleaner, primarily caused by the fan, is hereby achieved. The fan in the present embodiment of the air cleaner is also exposed to a reduced quantity of air particles in the airflow due to the installed position downstream of a filter. The abrasive wear of the fan is thereby advantageously reduced.

According to an advantageous embodiment of the device according to the invention, the air inlet is tapered in design, so that an air inlet area has a smaller cross-sectional area than a flow-through area. In this manner, the flow velocity of the intake air is advantageously increased at the air inlet, because the cross-sectional area permeated by the air is reduced, for example by means of conical air guide vanes tapering down from the flow-through area in the direction of the air inlet area. Optimized flow conditions at the air inlet and a larger air intake region in front of the air inlet are the advantageous results.

According to a further advantageous embodiment of the device according to the invention, the device comprises a control unit for controlling a cleaning power level as a function of an input parameter, wherein the control unit preferably comprises communication means for exchanging data with an external unit and/or a further device for cleaning air. The control unit is thereby designed for receiving data or information from communications partners, such as external units, such as external control units, and/or other devices for cleaning air, and for transmitting data or information to the same. Communications means for exchanging the information within the scope of the invention can be communications devices for mobile communications networks (LTE, UMTS, etc.), communications devices for Wi-Fi networks, communications devices for LAN networks, and/or communications devices for telephone and DSL networks. Data or information transmitted and/or received is preferably information about the traffic volume, information about air pollution, and/or information about the operating state of the device.

According to an advantageous embodiment of the device according to the invention, the device comprises means for determining a parameter characterizing air pollution and/or means for determining a parameter characterizing traffic volume and/or means for determining a sound level as an input parameter for the control unit. It is thereby advantageously made possible to control the cleaning power level of the device as a function of the air pollution, as a function of the traffic volume and/or the noise or sound level, and to achieve a desired purity of the air under consideration of the current boundary conditions. Controlling the cleaning power level of the device as a function of the air pollution is advantageous because the cleaning power level of the device is adapted to the current air pollution level in this manner. This means that in case of high air pollution, cleaning should take place at full power if possible, while at lower air pollution it is possible to reduce the cleaning power level in order to save energy. Controlling the cleaning power level of the device as a function of the traffic volume, that is, as a function of the quantity of motor vehicles passing by the device per unit of time, is advantageous because the primary sources of air pollution are motor vehicles, particularly in inner-city areas. Controlling the cleaning power level of the device as a function of the sound level is advantageous because certain sound level limits should not be exceeded in the context of potential noise pollution at particular times of day, particularly at night. The means for determining a parameter characterizing the air pollution are preferably sensors for measuring particulate matter concentration, sensors for measuring carbon dioxide concentration, and sensors for measuring nitrogen oxide concentration in the air. The means for determining a parameter characterizing air pollution can further comprise sensors for determining the wind direction, the oxygen content, the temperature, and/or the humidity. The means for determining a parameter characterizing the traffic volume are preferably optical sensors, radar sensors, laser scanners, and/or cameras. Traffic information services, similar to those of navigation systems, can also be used. The means for determining a sound level are preferably sound level measurement devices and/or microphones.

An arrangement of the type indicated above may be configured in such a way that at least some of the devices are implemented for exchanging data with each other and/or that an arrangement control unit is provided for controlling a cleaning power level of the arrangement, wherein at least some of the devices are implemented for exchanging data with the arrangement control unit. The arrangement is thereby advantageously implemented firstly for exchanging data between the devices and secondly for exchanging data with an arrangement control unit for controlling the cleaning power level of the devices. Data exchange with each other can take place by means of communications devices for mobile communications networks (LTE, UMTS, etc.), communications devices for Wi-Fi networks, communications devices for LAN networks, and/or communications devices for telephone and DSL networks. Data or information able to be exchanged with each other preferably includes information about traffic volume, measured values of air pollution, measured climate values, information about traffic volume, and/or information about the operating state of the devices, such as the current fan power. An arrangement control unit, preferably an industrial PC having a communications device for exchanging data by means of mobile communications networks, is also designed for receiving the information. The arrangement control unit can either be integrated in one of the devices or set up at an arbitrary location independently of the devices.

According to an advantageous embodiment of the device according to the invention, the device comprises air pollution measuring means for providing an input parameter characterizing the air pollution to the arrangement control unit. In this manner, the arrangement is advantageously implemented for controlling the cleaning power level of the devices as a function of the measured values determined by means of the air pollution measuring means, because the measured value of the air pollution measuring means are input parameters for the arrangement control unit. The air pollution measuring means can preferably be sensors for measuring the particulate matter concentration, sensors for measuring the carbon dioxide concentration, and/or sensors for measuring the nitrogen oxide concentration in the air. In addition, the air pollution measuring means can also preferably comprise sensors for determining the wind direction, the oxygen content, the temperature, and/or the humidity. The sensors can be mounted on the devices and can be mounted independently of the device, for example on air measuring stations, buildings, traffic lights, traffic signs, and/or the arrangement control unit.

According to a further advantageous embodiment of the arrangement according to the invention, the arrangement comprises vehicle detection means for providing an input parameter characterizing the traffic volume for the arrangement control unit. The arrangement is thereby advantageously designed for controlling the cleaning power level of the devices of the arrangement as a function of the traffic volume and for achieving a desired purity under consideration of the current boundary conditions. Controlling the cleaning power level of the device as a function of the traffic volume, that is, as a function of the quantity of motor vehicles passing by the device per unit of time, is advantageous because the primary sources of air pollution are motor vehicles, particularly in inner-city areas. One advantage of exchanging the information about the traffic volume between the devices and/or with the arrangement control unit is that a high traffic volume in the immediate surrounding area of a vehicle detection means can result in an increased traffic volume for a device for cleaning air if it is known that the motor vehicles will pass by the device due to the road routing. In this case, the cleaning power level of the device can be increased even before the motor vehicles arrive. The vehicle detection means are preferably optical sensors, radar sensors, laser scanners, and/or cameras. The sensors can either be mounted on the devices or can be mounted independently of the devices, for example on air measuring stations, buildings, traffic signs, and/or the arrangement control unit. Traffic information services, similar to those of navigation systems, can also be used as vehicle detection means.

According to a further advantageous embodiment of the arrangement according to the invention, the arrangement control unit comprises server means for making available in a data network the data of the vehicle detection means and/or data of the air pollution measuring means. In this manner, the arrangement control unit is designed for making available in a data network the data of the vehicle detecting means and/or the data of the air pollution measuring means, so that the data can be further processed by data network users and clients in a variety of ways. It is possible, for example, to make available in the data network information about the current traffic volume and/or the current air pollution at the various installation sites. In this manner, for example, joggers and cyclists can plan an optimal walking or riding route having as little pollution as possible on the basis of a corresponding data analysis.

According to an advantageous embodiment of the arrangement according to the invention, the arrangement control unit is implemented for determining required cleaning power levels of the devices on the basis of the data of the vehicle detecting means and/or the data of the air pollution measuring means and for transmitting the power levels to the devices. The arrangement is thereby advantageously implemented for controlling the cleaning power level of the devices as a function of the traffic volume and/or as a function of the air pollution. Controlling the cleaning power level of the device as a function of the traffic volume, that is, as a function of the quantity of motor vehicles passing by the device per unit of time, is advantageous because the primary sources of air pollution are motor vehicles, particularly in inner-city areas. Controlling the cleaning power level of the devices as a function of the air pollution is advantageous because the cleaning power level of the devices is adapted to the current air pollution level in this manner. This means that in case of high air pollution, cleaning should take place at full power if possible, while at lower air pollution it is possible to reduce the cleaning power level in order to save energy.

According to a further advantageous embodiment of the arrangement according to the invention, the arrangement control unit is implemented for calculating, on the basis of the data of the vehicle detecting means and/or the data of the air pollution measuring means, a traffic control for which the air pollution does not exceed a maximum air pollution value and/or is minimized. In order to ensure that certain air pollution maximum values are not exceeded, the arrangement control unit is implemented for calculating, on the basis of the data of the vehicle detecting means and/or the data of the air pollution measuring means, a traffic control resulting in lower air pollution. To this end, for example, measures such as modified traffic light circuits, intermittently blocking roads, and intermittently establishing one-way streets can be taken.

According to a further advantageous embodiment of the arrangement according to the invention, the arrangement control unit is implemented for calculating, on the basis of the data of the vehicle detecting means and/or the data of the air pollution measuring means, installation sites of the devices for cleaning air at which an optimal air cleaning result is obtained. In order to optimize the air cleaning results, the arrangement control unit is implemented for calculating an optimal geographic arrangement, that is, optimal installation sites, for the devices of the arrangement, in order to achieve optimal cleaning effectivity as much as possible under the given boundary conditions Repositioning of the devices can be performed on the basis of the calculated installation sites of the individual devices. It is further advantageous that it can often be assumed that particular boundary conditions, such as the traffic volume at particular times of day, will repeat, so that repositioning can be performed with a certain lead timed, because conclusions can be drawn about future events from experience and measured value curves from the past.

According to an advantageous embodiment of the arrangement according to any one of the claims, at least one device is implemented according to any one of the claims 1 through 24. Embodiments of the arrangement wherein different embodiment versions of the device for cleaning air are possible within the scope of the invention, particularly mobile embodiment versions, embodiment versions having deflected air guiding, and embodiments having fans disposed between the filter means are combined. A software-based application of the type indicated above may be implemented for communication with at least one controller of a device for cleaning air and/or for communicating with an arrangement control unit of an arrangement of devices for cleaning air. The software-based application is thereby advantageously implemented for communicating with the control units of a device for cleaning air and/or for communicating with an arrangement control unit of an arrangement of devices for cleaning air. The communicating can take place by means of communications devices for mobile communications networks (LTE, UMTS, etc.), communications devices for Wi-Fi networks, communications devices for LAN networks, and/or communications devices for telephone and DSL networks. Data or information able to be communicated with each other preferably includes information about traffic volume, measured values of air pollution, measured climate values, information about the operating state of the devices, such as the current fan power, and/or control commands for the fans of the devices.

According to an advantageous embodiment of the software-based application according to the invention, the application is implemented for providing and/or displaying information about air pollution and/or for providing and/or displaying information about the traffic volume. The software-based application is thereby implemented for making available and/or displaying to users information about current traffic volume and/or current air pollution at different installation sites. In this manner, for example, joggers and cyclists can plan an optimal walking or riding route having as little pollution as possible.

According to an advantageous embodiment of the software-based application according to the invention, the application is implemented for controlling a device for cleaning air and/or for controlling an arrangement of devices for cleaning air. In this manner, the software-based application is implemented for simply controlling devices for cleaning air and/or arrangements of devices for cleaning air. It is thereby made substantially easier particularly for operators of devices for cleaning air, such as municipalities, to control the devices and to deactivate the same rapidly for maintenance purposes, for example, or for repositioning procedures.

Embodiment examples of the invention are described in greater detail below using the drawings. Functionally identical parts are thereby labeled with the same reference numeral.

### BRIEF DESCRIPTION OF THE DRAWINGS

In the drawings,

FIG. 1 shows a schematic side view of an embodiment of the device according to the invention for cleaning air—mobile air cleaner;

FIG. 2 shows a schematic side view of an embodiment of the device according to the invention for cleaning air—mobile air cleaner;

FIG. 3 shows a schematic plan view of an embodiment of the arrangement according to the invention of devices according to the invention for cleaning air in a city;

FIG. 4 shows a schematic section view of a further embodiment of the device according to the invention for cleaning air—combination filter unit;

FIG. 5 shows a schematic perspective view of a further embodiment of the device according to the invention for cleaning air—mobile city air cleaner comprising three combination filter units per FIG. 4;

FIG. 6 shows a schematic perspective view of a further embodiment of the device according to the invention for cleaning air—mobile city air cleaner in a housing design;

FIG. 7 shows a side view of the embodiment of the device for cleaning air according to the invention per FIG. 6—city air cleaner in housing design;

FIG. 8 shows a schematic section view of a further embodiment of the device according to the invention for cleaning air—horizontal combination filter unit having air deflecting unit;

FIG. 9 shows a schematic perspective view of a further embodiment of the device according to the invention for cleaning air—mobile city air cleaner comprising three combination filter units per FIG. 8;

FIG. 10 shows a schematic section view of a further embodiment of the device according to the invention for cleaning air—vertical combination filter unit having air deflecting unit;

FIG. 11 shows a schematic perspective view of a further embodiment of the device according to the invention for cleaning air—mobile city air cleaner comprising three combination filter units per FIG. 10.

### DETAILED DESCRIPTION OF THE DRAWINGS

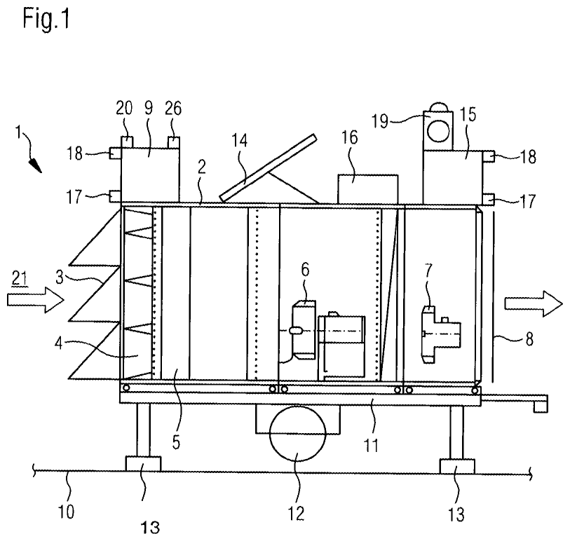

FIG. 1 shows a schematic side view of an air cleaning unit 1. Polluted air 21 from the surrounding area enters the housing 2 of the air cleaning unit 1 via the air inlet 3. The air 21 is transported by means of a fan 6 through a particulate matter filter 4 and an activated carbon filter 5, wherein the air is cleaned of pollutants, such as particulate matter and nitrogen oxides, by the two filters. The air 21 is then transported by means of the fan 6 across an exhaust wind generator 7 through the air outlet 8 back to the surrounding area of the air cleaning unit 1. The air cleaning unit 1 has a control unit 9 based on an industrial PC for performing the controlling of all functions of the air cleaning unit 1, such as the fan power, energy management, and/or communicating with peripheral units. The air cleaning unit 1 is presently installed on an asphalt road 10. For transporting, the air cleaning unit 1 has a chassis 11 comprising both wheels 12 for driving or rolling and supports 13 for stable support. For operating autonomously without an external electrical power connection, the air cleaning unit 1 has a photovoltaic system 14 mounted on the housing 2 of the air cleaning unit 1 and generating electricity when the sun shines. The air cleaning unit 1 also comprises an electrical power connection 15 by means of which an external electrical power source can be connected for operating the air cleaning unit 1. A battery 16 is further mounted on the housing 2 and is able to store electrical energy generated by the photovoltaic system 14. The battery can be used for operating the air cleaning unit 1. In order to be able to determine the pollution of the air 21 both at the air inlet 3 and at the air outlet 8, the air cleaning unit has particulate matter sensors 17 and nitrogen oxide sensors 18 at both the air inlet 3 and the air outlet 8.

In order to be able to determine the current traffic volume, a traffic camera 20 is present on the housing and captures all passing motor vehicles. The current sound level is also captured using a sound level measuring device (26). For communicating, the air cleaning unit comprises a communications device for mobile communications networks (LTE) 19, by means of which the control unit 9 can exchange information with peripheral units, such as other air cleaning units and/or non-central controllers.

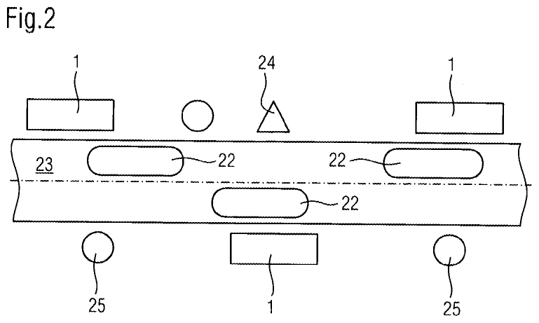

FIG. 2 shows a schematic plan view of an arrangement of a plurality of air cleaning units 1 along a road. The air cleaning units 1 are presently installed along a road 23 traveled by motor vehicles 22. The air cleaning units 1 communicate with the arrangement control unit 24 by means of the communications devices thereof for mobile communications networks (LTE) 19. A non-central air measuring unit 25 is also present at the road for determining air measurement values by means of a particulate matter sensor 17 and a nitrogen oxide sensor 18 and communicates the values to the arrangement control unit 24 by means of a communications device for mobile communications networks (LTE) 19.

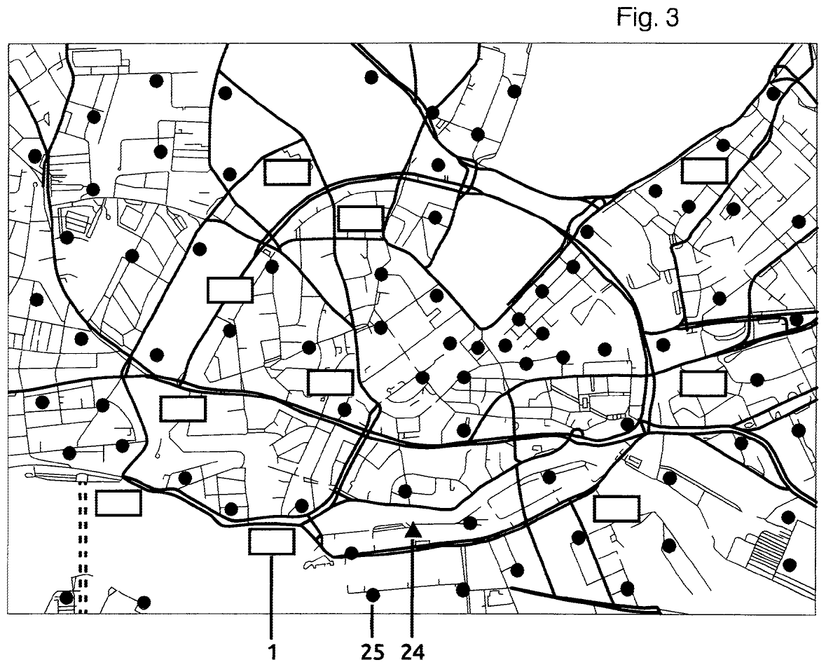

FIG. 3 shows a schematic plan view of an arrangement of a plurality of air cleaning units 1, air measuring units 25, and an arrangement control unit 24 in a city on a city map. The air cleaning units 1 and the air measuring units 25 are distributed around the entire city region shown and are connected to each other for exchanging information by means of the communications devices for mobile communications networks (LTE) 19 and the arrangement control unit 24. FIG. 3 also makes clear that air quality values for a plurality of locations are present due to the particulate matter sensors 17 and nitrogen oxide sensors 18 integrated in the individual air cleaning units 1 and the air measuring units 25. The same applies for the traffic information provided by the traffic cameras 20 integrated in the individual air cleaning units 1.

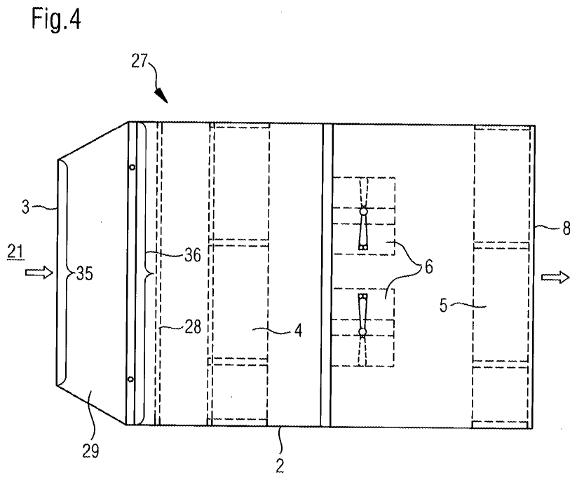

FIG. 4 shows a schematic section view of a combination filter unit 27 for an air cleaning unit. Polluted air of the surrounding area 21 enters the combination filter unit 27 via the air inlet 3 tapered down by means of air guide vanes 29. The flow velocity of the intake air 21 at the air inlet 3 in the region of the air intake area 35 is increased by the air guide vanes 29 relative to the flow velocity in the region of the flow-through area 36. The air 21 is transported through a pre-filter 28 and a particulate matter filter 4, here a pocket filter, by means of two fans 6 disposed adjacent to each other parallel to the flow direction, wherein the air 21 is cleaned of pollutants, particularly of particulate matter, by the two filters. The air 21 is then transported by means of the fans 6 across an activated carbon filter 5 through the air outlet 8 back to the surrounding area of the combination filter unit 27. The fans 6 are installed between the particulate matter filter 4 and the activated carbon filter 5 in order to keep the noise emissions of the combination filter unit 27 as low as possible. As explained in detail below, a plurality of combination filter units 27 can be combined into an air cleaning unit.

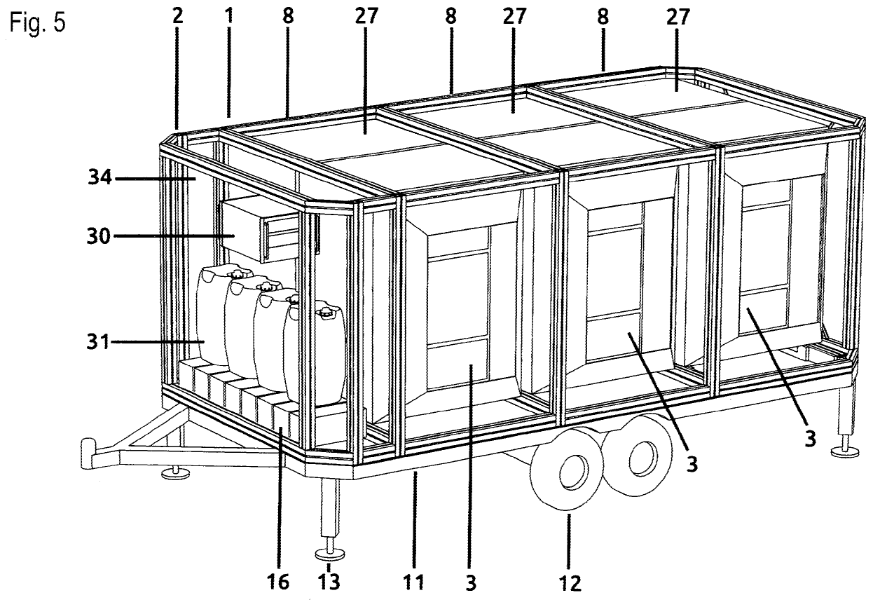

FIG. 5 shows a schematic perspective view of a mobile air cleaning unit 1. The air cleaning unit 1 comprises three combination filter units 27 per FIG. 4, mounted on a chassis 11 having a housing 3 and each comprising an air inlet 3 and an air outlet 8. The chassis 11 comprises wheels 12 in order to be able to be transported by a motor vehicle, for example. The chassis 11 also comprises supports 13 in order to able to be set up at a location at which the air is to be cleaned, for example, and to be able to compensate for unevenness in the ground. Batteries 16 are disposed in a storage space 34 in the front part of the housing 3 of the air cleaning unit 1 and supply electrical power to the combination filter units 27 of the air cleaning unit 1, particularly the fans 6 of the combination filter units 27; see FIG. 4. The batteries 16 are charged by means of fuel cells 30, in turn supplied with fuel, here methanol, by methanol tanks 30.

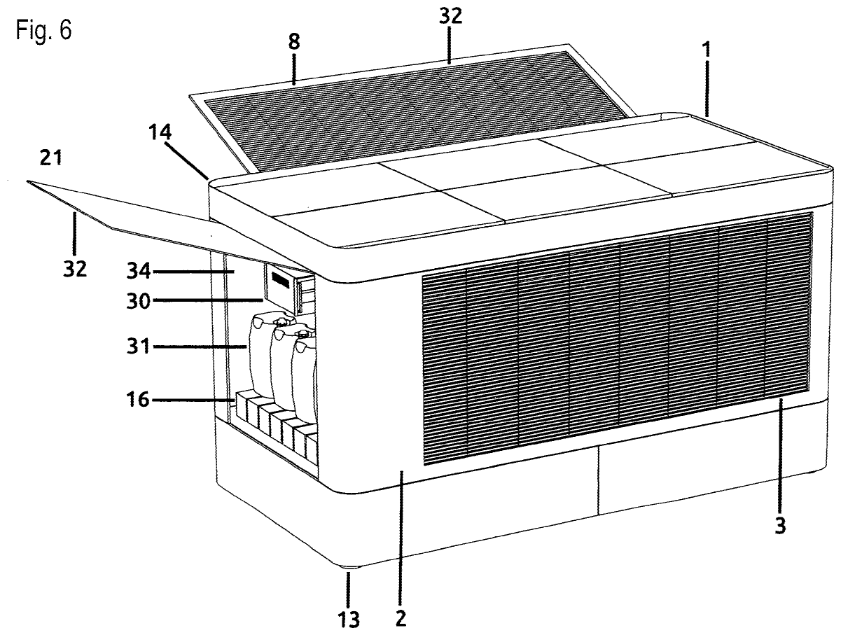

FIG. 6 shows a schematic perspective view of an air cleaning unit 1 in a housing design comprising the three combination filter units 27 from FIG. 4, not shown, in the interior of the housing 2. The air cleaning unit 1 is installed by means of height-adjustable supports 13 at a location where polluted air 21 is cleaned. The polluted air 21 of the surrounding area enters the air cleaning unit 1 via an air inlet 3 integrated in the housing 2, permeates the combination filter units 27, as described with reference to FIG. 4, and then exits to the surrounding area again through an air outlet 8 integrate in a double-wing door 32. Batteries 16 are disposed in a storage space 34 of the air cleaning unit 1 and supply electrical power to the combination filter units 27, particularly the fans 6 of the combination filter units 27; see FIG. 4. The batteries 16 are charged by means of fuel cells 30, in turn supplied with fuel, here methanol, by methanol tanks 30. The batteries can also be charged by a photovoltaic system 14 present on the housing 2 of the air cleaning unit 1.

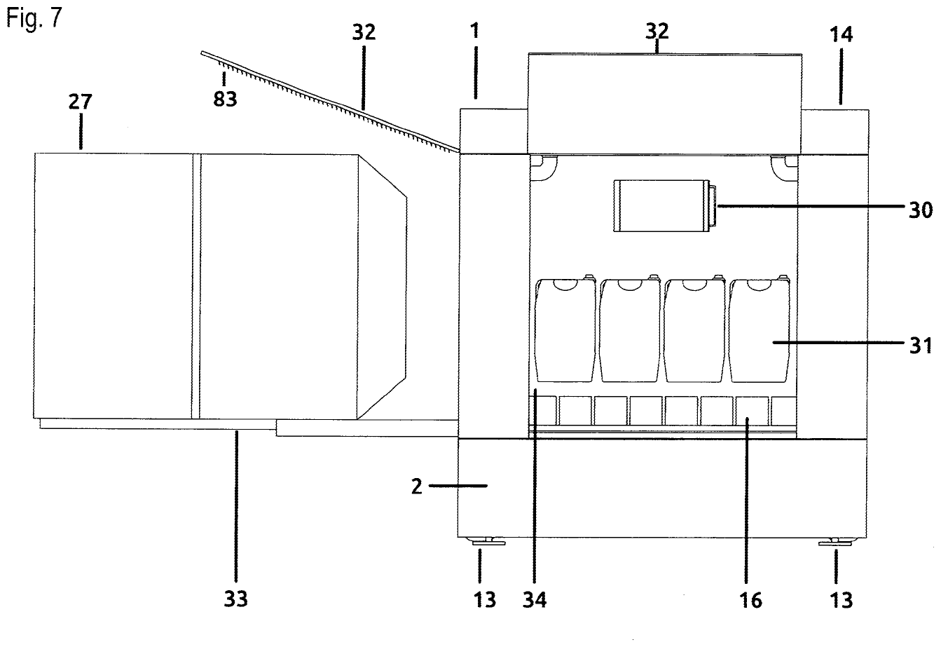

FIG. 7 shows a side view of the air cleaning unit 1 from FIG. 6. As can be seen, the air cleaning unit 1 comprises a pull-out system 33 in order to place combination filter units 27 from FIG. 4 into the housing 2 of the air cleaning unit 1. To this end, a double-wing door 32 comprising an air inlet 3 is opened. The pull-out system 33 facilitates both placing and removing the combination filter units 27, as the units are guided by the pull-out system 33. Maintenance of the combination filter units 27 is also advantageously facilitated in this manner; batteries 16 are disposed in a storage space 34 of the housing 2 of the air cleaning unit 1 and supply electrical power to the combination filter units 27, particularly the fans 6 of the combination filter units; see FIG. 4. The batteries 16 are charged by means of fuel cells 30, in turn supplied with fuel, here methanol, by methanol tanks 30. The batteries can also be charged by a photovoltaic system 14 present on the housing 2 of the air cleaning unit 1.

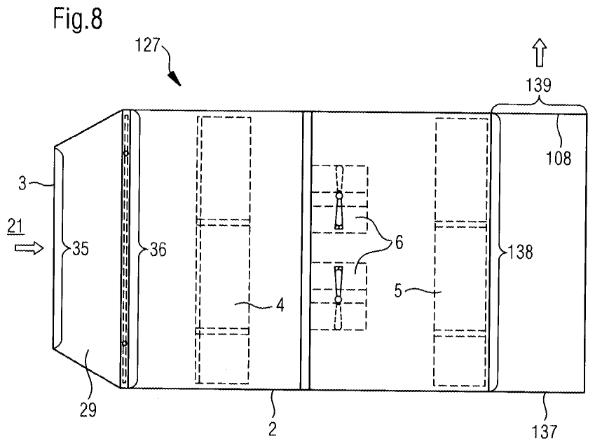

FIG. 8 shows a schematic section view of a combination filter unit 127 for an air cleaning unit. The structure corresponds to the combination filter unit 27 from FIG. 4. Deviating from the embodiment in FIG. 4, however, the air 21 is deflected by 90 degrees by an air deflecting unit 137 upstream of the air outlet, so that the air 21 is blown out of the combination filter unit 127 deflected at the air outlet 108 by 90 degrees from the air flow direction in the housing 2 and from the air flow direction at the air inlet 3. When the combination filter unit 127 is used properly, this means that the air 21 at the air inlet 3 is taken in horizontally by means of the fans 6 in the combination filter unit 127 and is blown out of the combination filter unit 127 vertically upward at the air outlet 108 by means of the fans 6, that is, opposite the earth's gravitational field. Here the air deflecting unit 137 is welded together from four metal sheets into a box have two openings offset 90 degrees from each other.

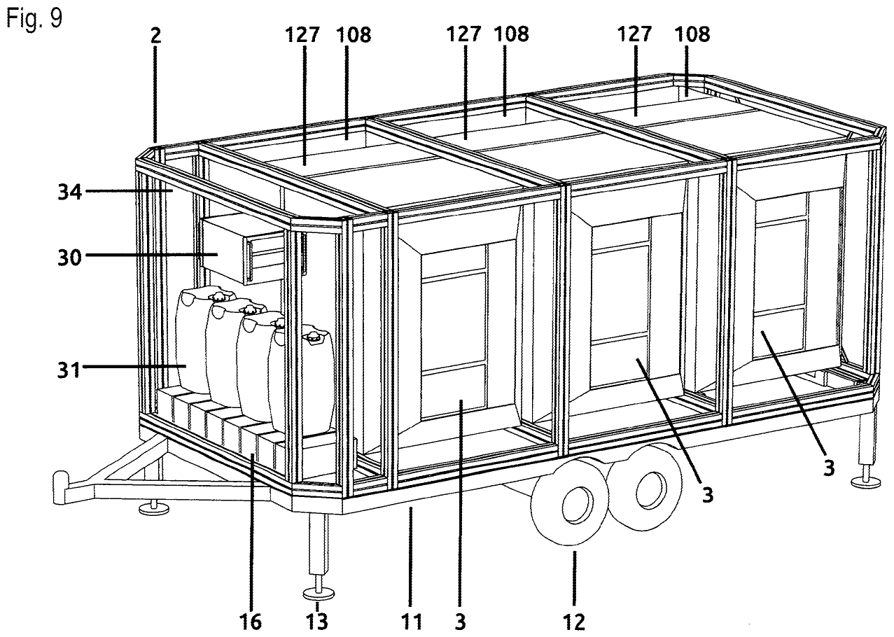

FIG. 9 shows a schematic perspective view of a mobile air cleaning unit 1. The construction of the air cleaning unit 1 corresponds substantially to the construction of the air cleaning unit from FIG. 5. Deviating from the embodiment in FIG. 5, however, the air cleaning unit 1 comprises three combination filter units 127 per FIG. 8, so that the air 21 is blown out of the combination filter unit 127 at the air outlet 108 deflected by 90 degrees from the intake direction of the air 21 at the air inlet 3. When the air cleaning unit 1 is used properly, this means that the air 21 is taken into the combination filter units 127 horizontally at the air inlets 3 and is blown out of the combination filter units 127 of the air cleaning unit 1 at the air outlets 108 vertically upward, that is, opposite the earth's gravitational field.

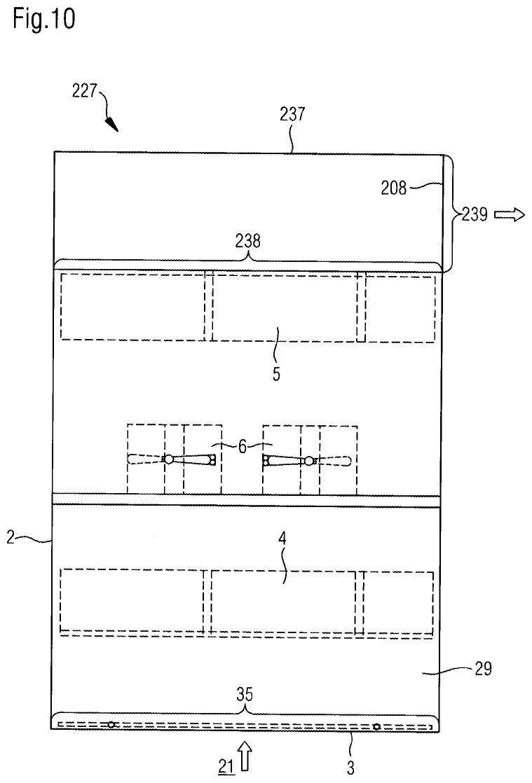

FIG. 10 shows a schematic section view of a combination filter unit 227 for an air cleaning unit. The structure corresponds to the combination filter unit 127 from FIG. 8. Deviating from the embodiment in FIG. 8, however, the combination filter unit 227 is not designed for horizontal, but rather for vertical operation. When the combination filter unit 227 is used properly, this means that the air 21 at the air inlet 3 is taken in vertically upward, that is, opposite the earth's gravitational field, by means of the fans 6 in the combination filter unit 227 and is blown out of the combination filter unit 27 horizontally at the air outlet 208 by means of the fans 6.

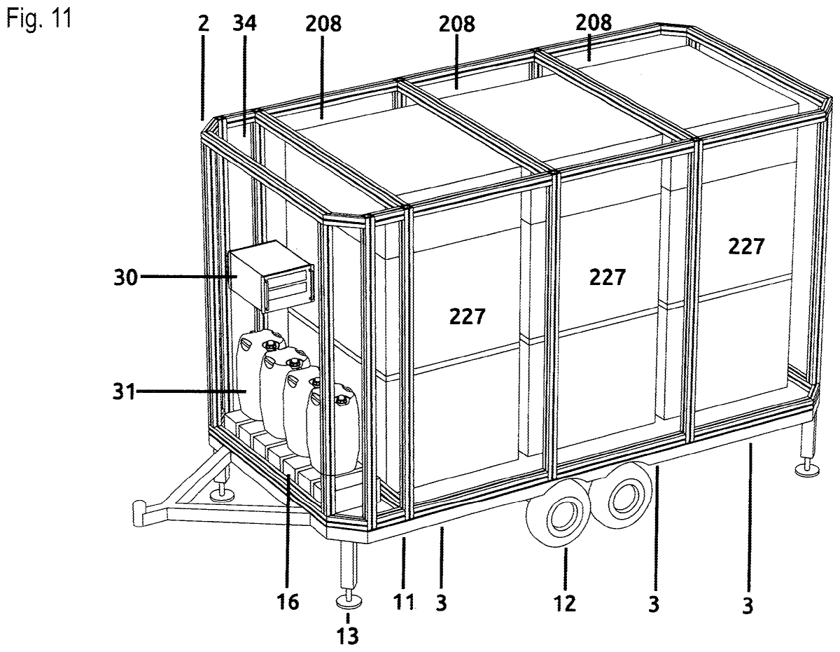

FIG. 11 shows a schematic perspective view of a mobile air cleaning unit 1. The structure of the air cleaning unit 1 corresponds substantially to the structure of the air cleaning unit from FIG. 9. Deviating from the embodiment in FIG. 9, however, the air cleaning unit 1 comprises three combination filter units 227 per FIG. 10, so that when the air cleaning unit 1 is used properly the air 21 is taken into the combination filter units 227 of the air cleaning unit 1 vertically upward, that is, opposite the earth's gravitational field, at the air inlets 3 and is blow out of the combination filter units 227 of the air cleaning unit 1 horizontally at the air outlets 208.

The application of the device according to the invention for cleaning air, the arrangement of a plurality of devices for cleaning air, and the software-based application for devices for cleaning air are explained below:

The air cleaning unit 1 is transported to the installation site by means of the chassis 11, if present in the design, and is positioned on the installation surface, here an asphalt road 10, by means of the supports 13. The air cleaning unit 1 is then connected to an external electrical power source by means of the electrical power connection 15 in order to provide the electrical power for operating, and is put into operation. If no external electrical power source is present, or the air cleaning unit 1 does not comprise an electrical power connection 15, then operating takes place by means of the photovoltaic system 14 and/or the electrical energy stored in the batteries 16, charged either by a fuel cell 30, the electrical power connection 15, or the photovoltaic system 14, depending on the design.

When the air cleaning unit 1 is put into operation, the air 21 of the surrounding area is transported by the fan(s) 6 via the air inlet 3 through the particulate matter filter 4 and the activated carbon filter 5 and is cleaned of pollutants such as particulate matter and nitrogen oxides, wherein the fan 6 or fans 6 are installed between the particulate matter filter 4 and the activated carbon filter 5 in some designs. For some designs, a pre-filter 28 can also be present. Along the air guides in the housing 2 of the air cleaning unit 1, the air 21 can be transported further across an exhaust wind generator 7 in some designs, by means of which part of the energy required for transporting the air 21 is recaptured. The air 21 is then returned to the surrounding area via the air outlet 8, 108, 208.

During operation, measured values are continuously determined at the air inlet 3 and the air outlet 8 by means of particulate matter sensors 17 and nitrogen oxide sensors 18 in order to be able to evaluate the cleaning effect of the air cleaning unit 1. Data about the current traffic volume is also recorded continuously during operation by means of a traffic camera 20. Both the data of the traffic camera 20 and the measured values of the particulate matter sensors 17 and nitrogen oxide sensors 18 are transmitted to the control unit 9. The control unit 9 uses the data and measured vales firstly for operating the air cleaning unit 1 controlled by traffic and air pollution. Secondly, the control unit 9 transmits the data and measured values to the arrangement control unit 24 by means of the communications device for mobile communications networks (LTE) 19. The arrangement control unit 24 additionally receives measurement data from other air cleaning units 1 and non-central air measuring units 25 firstly used for coordinated operation of the air cleaning units 1 and secondly made available to users of a smartphone application by means of a server integrated in the arrangement control unit 24.

Thus various embodiments of a device for cleaning air, particularly outdoors, an arrangement of a plurality of devices for cleaning air, and a software-based application, particularly a smartphone application, for devices for cleaning air are disclosed, being inexpensive and simple to use, and enabling the user to clean pollutants from air at arbitrary times and arbitrary places.

### LIST OF REFERENCE NUMERALS

1 Air cleaning unit

2 Housing

3 Air inlet

4 Particulate matter filter

5 Activated carbon filter

6 Fan

7 Exhaust wind generator

8 Air outlet

9 Control unit

10 Asphalt road

11 Chassis

12 Wheels

13 Supports

14 Photovoltaic system

15 Electrical power connection

16 Battery

17 Particulate matter sensor

18 Nitrogen oxide sensor

19 Communications device for mobile communications networks (LTE)

20 Traffic camera

21 Air

22 Motor vehicle

23 Road

24 Arrangement control unit

25 Non-central air measuring unit

26 Sound level measuring device

27 Combination filter unit

28 Pre-filter

29 Air guide vane

30 Fuel cell

31 Methanol tanks

32 Double-wing door

33 Pull-out system

34 Storage space

35 Air intake area

36 Flow-through area

108 Air outlet

127 Combination filter unit

137 Air deflecting unit

138 Air deflecting unit inlet area

139 Air deflecting unit outlet area

208 Air outlet

227 Combination filter unit

237 Air deflecting unit

238 Air deflecting unit inlet area

239 Air deflecting unit outlet area

1. A device for cleaning air, comprising a housing (2) having at least one air inlet (3), at least one filter (4, 5), at least one fan (6), and at least one air outlet (8, 108, 208), wherein the device is transportable and configured for positioning at different installation sites.

2. The device according to claim 1, wherein the device comprises a chassis (11) having wheels (12).

3. The device according to claim 2, further comprising a motor for driving the wheels (12).

4. The device according to claim 1, wherein the device is configured for autonomous mobility.

5. The device according to claim 1, further comprising a power supply (7, 14, 15, 16, 30).

6. The device according to claim 5, wherein the power supply comprises at least one of a photovoltaic system (14), a fuel cell (30), an electrical power connection (15), a rechargeable battery, and a power generator.

7-9. (canceled)

10. The device according to claim 1, further comprising a device control unit (9) for controlling a cleaning power level as a function of an input parameter, wherein the device control unit (9) is configured for exchanging data with at least one of an external unit and a further device (1) for cleaning air (21).

11. The device according to claim 1, further comprising at least one sensor for for determining a parameter (17, 18) characterizing air pollution, for determining a parameter (20) characterizing traffic volume, or for determining a sound level (26) as an input parameter for the control unit.

12. The device according to claim 1, wherein a flow direction of the air at the air inlet (3) is at a right angle to a flow direction at the air outlet (8, 108, 208) when the device is used properly.

13. The device according to claim 12, further comprising an air deflector (137, 237) disposed between the air inlet (3) and the air outlet (8, 108, 208).

14. The device according to claim 13, wherein an air deflector inlet area (138, 238) is greater than an air deflector outlet area (139, 239), the air deflector inlet area (138, 238) preferably being approximately three times as great as the air deflector outlet area (139, 239).

15. The device according to claim 1, wherein at least one of the at least one fan (6) is configured as an in-line fan, as a fan having a controllable disc armature motor, or as a fan having reverse-curved blades.

16. The device according to claim 1, wherein the at least one filter comprises a pre-filter, a particulate matter filter and an activated carbon filter, wherein at least one of the at least one fan (6) is disposed between particulate matter filter (4) and the activated carbon filter (5) or between the pre-filter (28) and the particulate matter filter means (4) along a flow direction.

17. The device according to claim 1, wherein an air inlet (3) is tapered to define an air intake area (35) having a smaller cross-sectional area than a flow-through area (36).

18. (canceled)

19. The device according to claim 1, wherein the housing (2) has dimensions of a standard container with two horizontal dimensions and one vertical dimension, wherein at least one of the two horizontal dimensions is greater than the vertical dimension.

20. The device according to claim 1, wherein the housing (2) is configured for a flow direction horizontal to an installation surface (10).

21. The device according to claim 1, wherein the air inlet (3) of the housing (2) is configured to be disposed at a height between 1.5 m and 2.5 m above an installation surface (10) during operation.

22. The device according to claim 1, wherein the at least one filter includes a first filter and a second filter, wherein at least one of the first filter and the second filter comprises a pre-filter (28), a matter filter (4), or an activated carbon filter (5).

23. The device according to claim 1, wherein at least one of the at least one filter (4, 5) comprises threads with a coating for triboelectrically charging by an air flow, the coating comprising a hydrophobic coating material.

24. The device according to claim 1, wherein at least one of the at least one filter (4, 5) comprises threads having a core with a coating including a heat-activated adhesive for materially bonding to itself or to other threads, wherein the core has a higher melting point than the adhesive, wherein the coating comprises a hydrophobic repellent.

25. A system comprising a plurality of devices for cleaning air according to claim 1, wherein at least some of the devices (1) are configured for exchanging data with each other, and wherein an arrangement control unit (24) is configured for controlling a cleaning power level of the arrangement, wherein at least some of the devices (1) are configured for exchanging data with the arrangement control unit (24).

26. The system according to claim 25, further comprising an air pollution sensor (17, 18) for providing an input parameter characterizing an air pollution for the arrangement control unit (24) and a vehicle detector (20) for providing an input parameter characterizing a traffic volume for the arrangement control unit (24).

27. The system according to claim 26, wherein the arrangement control unit (24) comprises a server storage for providing data of the vehicle detector (20) or data of the air pollution measuring means (17, 18) in a data network.

28. (canceled)

29. The system according to claim 26, wherein the arrangement control unit (24) is configured for calculating, based on the data of at least one of the vehicle detector (20) and the air pollution measuring means (17, 18), at least one of the following quantities:
required power levels of the plurality of devices (1) based on the data of at least one of the vehicle detector (20) and of the air pollution sensor (17, 18);
a traffic control resulting in an air pollution that does not exceed a predetermined air pollution value
installation sites of the plurality of devices for cleaning air (1) at which an optimal air cleaning result is obtained;

30-31. (canceled)

32. A software-based application for controlling and air-cleaning process of at least one device according to claim 1, wherein the application is configured for communicating with at least one device control unit (9) of a device (1) for cleaning air (21) or for communicating with an arrangement control unit (24) of an arrangement of devices (1) for cleaning air (21).

33. The software-based application according to claim 32, wherein the application is configured for providing information about air pollution or for providing information about traffic volume.

34. The software-based application according to claim 32, wherein the application is configured for controlling a device (1) for cleaning air (1) or for controlling an arrangement of devices (1) for cleaning air (21).
